(19) United States
(12) Patent Application Publication
(10) Pub. No.: US 2023/0399214 A1
(43) Pub. Date: Dec. 14, 2023

(54) BLOCK-TYPE AERIALAERIAL WORK PLATFORM WITH EASY HEIGHT ADJUSTMENT

(71) Applicant: Jae Hyung WOO, Incheon (KR)

(72) Inventor: Jae Hyung WOO, Incheon (KR)

(21) Appl. No.: 18/034,715

(22) PCT Filed: Jun. 10, 2022
(86) PCT No.: PCT/KR2022/008198

§ 371 Date: May 1, 2023

(30) Foreign Application Priority Data
Jun. 22, 2021 (KR) 10-2021-0080679

(51) Int. Cl. B66F 11/04

(52) U.S. Cl. CPC B66F 11/042

(57) ABSTRACT

A block-type aerial work platform facilitating height adjustment includes: a moving means (10) provided as a quadrangular frame (100) equipped with rollers (101) so as to be movable to a work position; a work platform (20) on which an operator boards to perform aerial work; and a lifting/lowering means (30) foldably installed between the moving means (10) and the work platform (20) to lift/lower the work platform (20).

### BACKGROUND

The present invention relates to an aerial work platform, and more specifically, to a block-type aerial work platform with easy height adjustment, which has a work platform provided with a detachable block-type lifting/lowering means in multiple stages to be able to remove or add a block-type lifting/lowering means without needing to replace the work flatform with a separate aerial or low-place work platform depending on a work position regardless of whether it is aerial work or low-place work, thereby improving convenience and speed of movement to increase work efficiency and economic feasibility.

In general, an aerial work platform is a device that can be accessed quickly and safely during aerial work, and is widely used in electrical work, duct work, plastering work, etc.

A typical aerial work platform is composed of a moving means equipped with wheels to be movable to a work position, a work platform on which an operator boards to perform aerial work, and a lifting/lowering means foldably installed between the moving means and an upper end portion of the work platform so as to lift/lower the work platform.

Since the wheels are enabled to move forward and backward by the moving means configured as described above, the aerial work platform is moved to a position for aerial work, and then an operator boards the work platform with equipment for work, etc., and the work platform is lifted by the operation of the lifting/lowering means and the work is performed while the work platform is stopped at the work position, and when the work is completed, the work platform is lowered to the original position by the operation of the lifting/lowering means.

However, since the maximum elongation length of the typical aerial work platform is limited, work at a higher work position requires a separate aerial work platform, and at a relatively low work position, the work platform should be lowered to a suitable height by a lifting/lowering means and then moved the working position. At this time, in the process of lowering the work platform by adjusting the hydraulic pressure of the lifting/lowering means while an operator is on board, there is a problem of safety accidents in which the work platform is suddenly lowered due to an unexpected defect in the lifting/lowering means due to poor control of the hydraulic pressure or other causes that have not been identified, causing the operator to fall or get injured.

Furthermore, the same problem occurs during lifting the work platform, which is the other way around, and there are many issues that need to be addressed to solve various problems occurring in a work process when an aerial work platform a fixed maximum elongation length is used, such as the need of a separate aerial work platform when the work position is even higher, in particular.

### SUMMARY OF THE INVENTION

In order to solve the above problems,

an objective of the present invention is to provide a block-type aerial work platform with easy height adjustment, which has a work platform provided with a detachable block-type lifting/lowering means in multiple stages to be able to remove or add a block-type lifting/lowering means without needing to replace the work platform with a separate aerial or low-place work platform depending on a work position regardless of whether it is aerial work or low-place work, thereby improving convenience and speed of movement to increase work efficiency and economic feasibility.

Specific solution means to achieve the above objective is a block-type aerial work platform with easy height adjustment, which is characterized by including:

a moving means 10 provided as a quadrangular frame 100 equipped with rollers 101 so as to be movable to a work position; a work platform 20 on which an operator boards to perform aerial work; and a lifting/lowering means 30 foldably installed between the moving means 10 and the work platform 20 so as to lift/lower the work platform 20, wherein the lifting/lowering means 30 includes a plurality of detachably-stacked block-type lifting/lowering means 300, each having fixing frames 310 provided on both upper and lower sides, wherein between the fixing frames 310, a plurality of lift arms 340 are pivotally connected to each other at both end portions and middle portions thereof by pivot pins 341, and

the moving means 10 includes:

a fixing bar 110 having one side fixedly coupled to a pivot pin 341 provided in the center of the ‘X’-shaped lift arm 340 provided in the block-type lifting means 300 provided at the lowermost side; a lifting/lowering bar 120 having an elongated hole 121 formed therethrough and fixedly coupled to the other side of the fixing bar 110; a connecting bar 130 having a pin 131, which slides along the elongated hole 121, provided on one side, and having the other side fixedly coupled to a horizontal bar 140; a long horizontal bar 140 fixedly coupled at predetermined positions between opposite sides of the frame 100 and protruding outward from the opposite sides of the frame 100, thereby fixedly coupled to support bars 150; and the support bar 150 having one end fixedly coupled to the horizontal bar 140, and having the other end provided with a seating part 154 composed of a seating rod 153 having a pivot handle 151 penetratively coupled to an upper end thereof and having a contact plate 152 provided at a lower end thereof, wherein

the block-type lifting/lowering means 300 includes the fixing frame 310 provided vertically in a quadrangular shape, a long guide rail 320 provided at both opposite lower ends of fixing frame 310, a sliding rod 330 to which one side of the lift arm 340 is coupled in a state in which the sliding rod 330 has a roller 331 provided at one end thereof so as to be slidable along the guide rail 320, and the lift arm 340 formed in an ‘X’ shape in a state in which the lift arm 340 has the pivot pin 341 provided in the center thereof so as to be foldable and expandable by the pivot pin 341, wherein

the vertically-stacked block-type lifting/lowering means 300 includes the vertically-provided fixing frame 310 detachably fastened to each other with a coupling bracket 350, and

the fixing frame 310 provided on a lower side of the block-type lifting/lowering means 300 formed in multiple stages comprises a DC actuator 360 to enable the plurality of lift arms 340 to be rotatably lifted and lowered by the pivot pin 341.

The present invention configured as described above exhibits an effect of

increasing work efficiency and economic feasibility by having a work platform provided with a detachable block-type lifting/lowering means in multiple stages to be able to remove or add a block-type lifting/lowering means without having to replace the same with a separate aerial or low-place work platform depending on a work position regardless of whether it is aerial work or low-place work, thereby improving convenience and speed of movement.

### BRIEF DESCRIPTION OF THE DRAWINGS

FIG. 1 is an overall perspective view of a block-type aerial work platform with easy height adjustment according to the present invention in a folded state,

FIG. 2 is an overall perspective view of a lifting/lowering means in a lifted state in a block-type aerial work platform with easy height adjustment according to the present invention,

FIG. 3 is an exploded perspective view of a block-type aerial work platform with easy height adjustment according to the present invention,

FIG. 4 is a perspective view of a moving means in a stated of being coupled to a part of a block-type lifting/lowering means in a block-type aerial work platform with easy height adjustment according to the present invention,

FIG. 5 is a plan view showing a state in which a support bar is opened in a block-type aerial work platform with easy height adjustment according to the present invention,

FIG. 6 is a side view showing a state in which a support bar is opened in a block-type aerial work platform with easy height adjustment according to the present invention,

FIG. 7 is a side view of a block-type aerial work platform with easy height adjustment according to the present invention in a state in which one block-type lifting/lowering means is installed and lifted/lowered and the remaining block-type lifting/lowering means are removed,

FIG. 8 is a side view of a block-type aerial work platform with easy height adjustment according to the present invention in a state in which two block-type lifting/lowering means are installed and lifted/lowered and the remaining block-type lifting/lowering means are removed, and

FIG. 9 is a side view of a block-type aerial work platform with easy height adjustment according to the present invention in a state in which three block-type lifting/lowering means are installed and lifted/lowered and the remaining block-type lifting/lowering means are removed.

### DETAILED DESCRIPTION OF THE INVENTION

Specific solution means to achieve the above objective is to provide a block-type aerial work platform with easy height adjustment, which includes a moving means 28 provided as a quadrangular frame 100 equipped with rollers 101 so as to be movable to a work position a work platform 20 on which an operator boards to perform aerial work, and a lifting/lowering means 30 foldably installed between the moving means 10 and the work platform 20 so as to lift/lower the work platform 20, wherein the lifting/lowering means 30 includes a plurality of detachably-stacked block-type lifting/lowering means 300, each having fixing frames 310 provided on both upper and lower sides, wherein between the fixing frames 310, a plurality of lift arms 340 are pivotally connected to each other at both end portions and middle portions thereof by pivot pins 341, and

the moving means 10 includes

a fixing bar 110 having one side fixedly coupled to a pivot pin 341 provided in the center of the ‘X’-shaped lift arm 340 provided in the block-type lifting means 300 provided at the lowermost side, a lifting/lowering bar 120 having an elongated hole 121 formed therethrough and fixedly coupled to the other side of the fixing bar 110, a connecting bar 130 having a pin 131, which slides along the elongated hole 121, provided on one side, and having the other side fixedly coupled to a horizontal bar 140, a long horizontal bar 140 fixedly coupled at a predetermined position between opposite sides of the frame 100 and protruding outward from the opposite sides of the frame 100, thereby fixedly coupled to support bars 150, and the support bar 150 having one end fixedly coupled to the horizontal bar 140, and having the other end provided with a seating part 154 composed of a seating rod 153 having a pivot handle 151 penetratively coupled to an upper end thereof and having a contact plate 152 provided at a lower end thereof, wherein

the block-type lifting/lowering means 300 includes the fixing frame 310 provided vertically in a quadrangular shape, a long guide rail 320 provided at both opposite lower ends of fixing frame 310, a sliding rod 330 to which one side of the lift arm 340 is coupled in a state in which the sliding rod 330 has a roller 331 provided at one end thereof so as to be slidable along the guide rail 320, and the lift arm 340 formed in an ‘X’ shape in a state in which the lift arm 340 has the pivot pin 341 provided in the center thereof so as to be foldable and expandable by the pivot pin 341, wherein

the vertically-stacked block-type lifting/lowering means 300 includes the vertically-provided fixing frame 310 detachably fastened to each other with a coupling bracket 350, and the fixing frame 310 provided on a lower side of the block-type lifting/lowering means 300 formed in multiple stages comprises a DC actuator 360 to enable the plurality of lift arms 340 to be rotatably lifted and lowered by the pivot pin 341.

Specific structural or functional descriptions of embodiments according to the concept of the present invention disclosed in the present specification are only illustrated for the purpose of describing the embodiments according to the concept of the present invention, and the embodiments according to the concept of the present invention may be variously modified and may have various forms, and thus may include all changes, equivalents, or alternatives falling within the spirit and technical scope of the present invention, and it will be understood that words or terms used in the present specification and claims of the present invention should not be construed as being limited to having meanings defined in commonly used dictionaries, but should be interpreted as having meanings and concepts consistent with the technical idea of the present invention, based on the principle that an inventor may properly define the concept of terms in order to best describe his or her invention. Therefore, the embodiments described in the specification of the present invention and the configurations illustrated in the drawings are only the most preferred embodiment of the present invention and do not represent all the technical ideas of the present invention, and thus it should be understood that various equivalents and modifications that can replace the present invention may be possible or may be present at the time of the application of the present invention.

In addition, unless otherwise defined in the specification of the present invention, all terms used herein, including technical or scientific terms, have the same meanings as those commonly understood by those skilled in the art to which the present invention belongs. Terms such as those defined in a dictionary commonly used should be construed as having meanings consistent with meanings in the context of the related art, and should not be construed as having ideal or overly formal meanings unless explicitly defined in the present specification.

Hereinafter, a preferred embodiment of the present invention will be described with reference to the accompanying drawings.

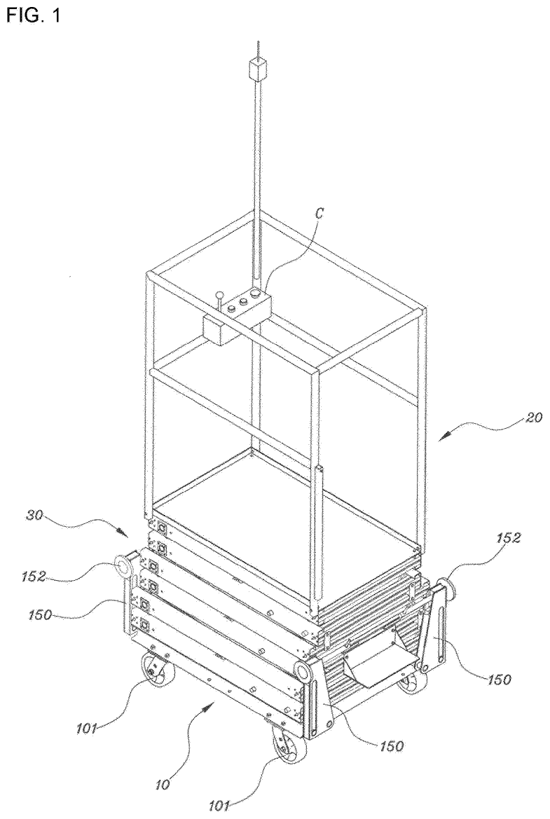

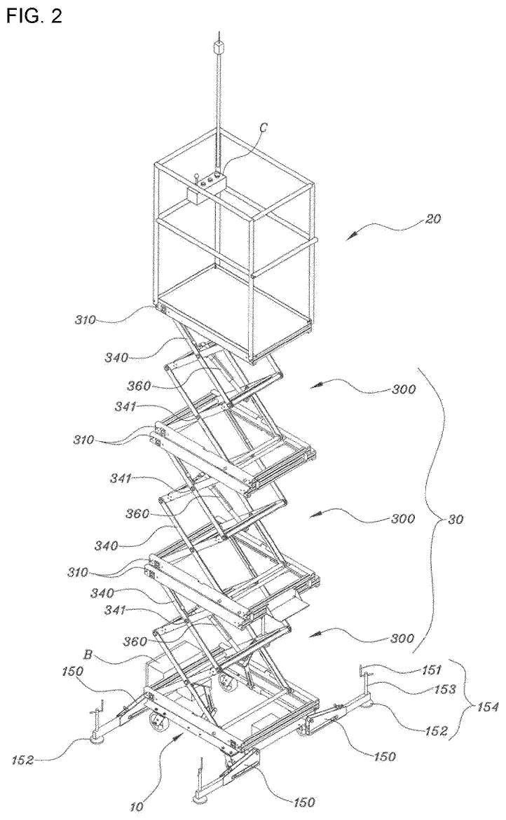

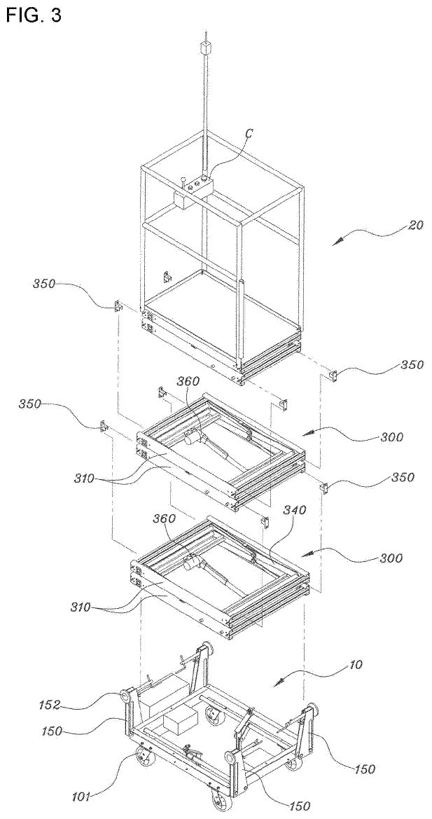

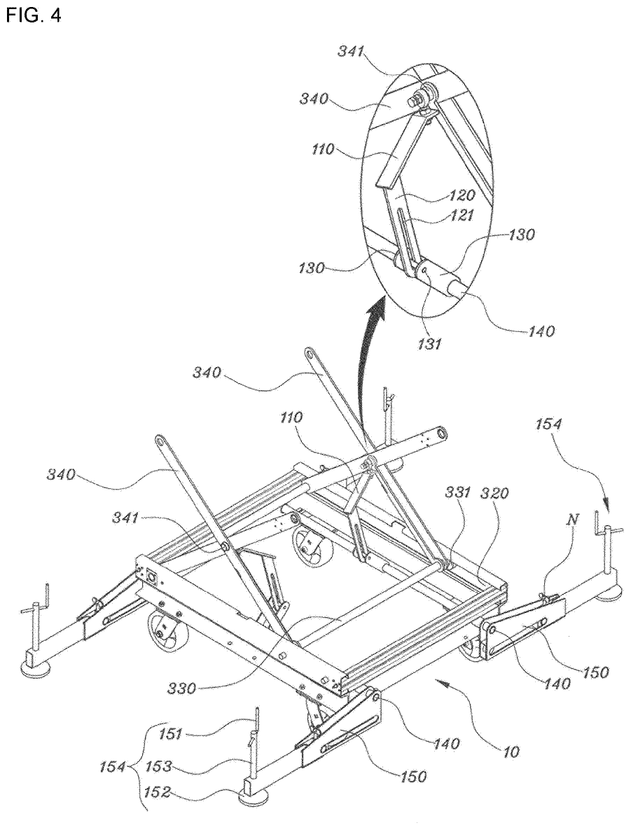

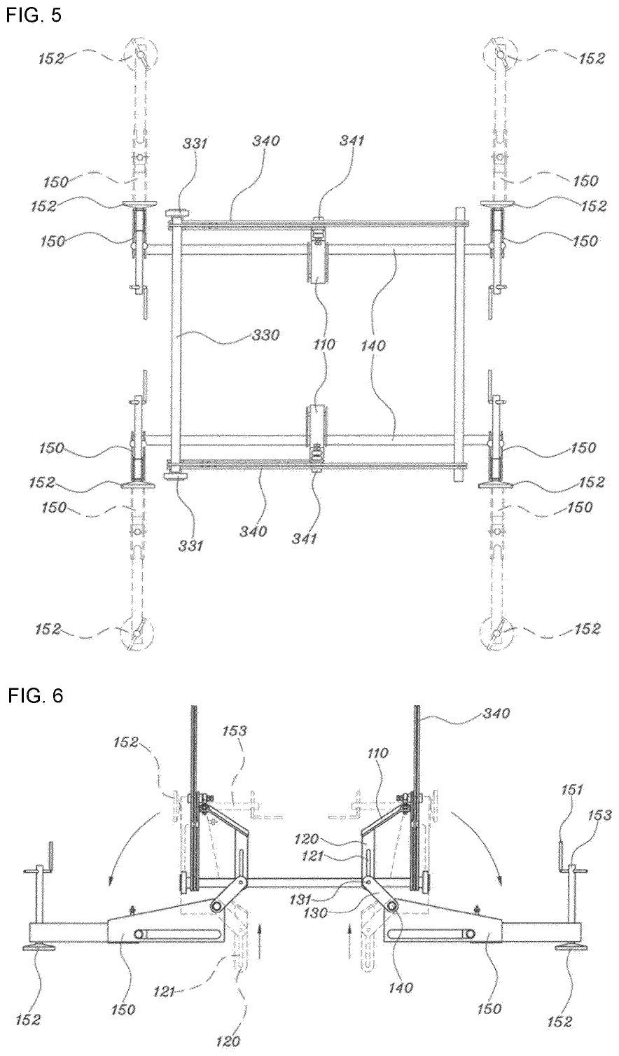

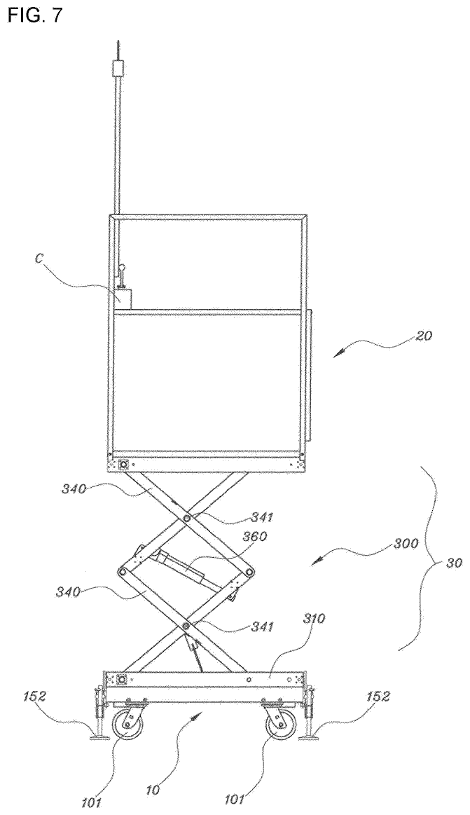

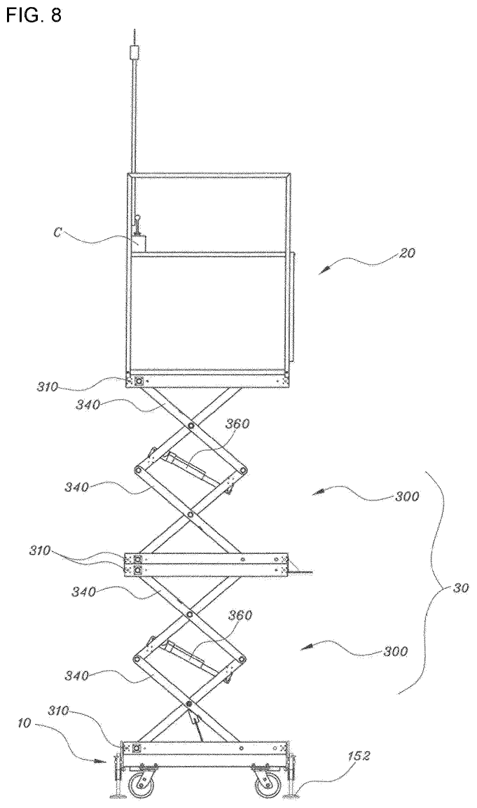

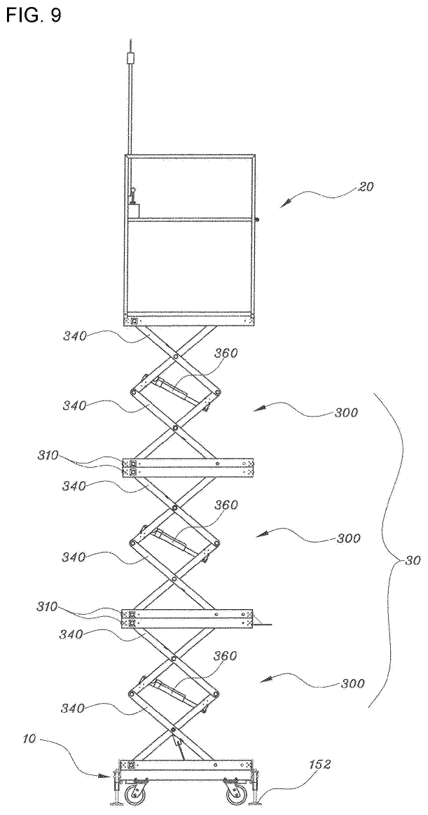

FIG. 1 is an overall perspective view of a block-type aerial work platform with easy height adjustment according to the present invention in a folded state, FIG. 2 is an overall perspective view of a lifting/lowering means in a lifted state in a block-type aerial work platform with easy height adjustment according to the present invention, FIG. 3 is an exploded perspective view of a block-type aerial work platform with easy height adjustment according to the present invention, FIG. 4 is a perspective view of a moving means in a stated of being coupled to a part of a block-type lifting/lowering means in a block-type aerial work platform with easy height adjustment according to the present invention, FIG. 5 is a plan view showing a state in which a support bar is opened in a block-type aerial work platform with easy height adjustment according to the present invention, FIG. 6 is a side view showing a state in which a support bar is opened in a block-type aerial work platform with easy height adjustment according to the present invention, FIG. 7 is a side view of a block-type aerial work platform with easy height adjustment according to the present invention in a state in which one block-type lifting/lowering means is installed and lifted/lowered and the remaining block-type lifting/lowering means are removed, FIG. 8 is a side view of a block-type aerial work platform with easy height adjustment according to the present invention in a state in which two block-type lifting/lowering means are installed and lifted/lowered and the remaining block-type lifting/lowering means are removed, and FIG. 9 is a side view of a block-type aerial work platform with easy height adjustment according to the present invention in a state in which three block-type lifting/lowering means are installed and lifted/lowered and the remaining block-type lifting/lowering means are removed.

The present invention will be described in detail.

First, the present invention not only functions as an aerial work platform but also is used for loading equipment, loads, etc., and transporting the same using rollers 100 on the ground since the work platform 20 is provided with a handle bar.

The present invention can be mainly divided into a moving means 10, a work platform 20, and a lifting/lowering means 30, and the above components are indispensable components that are already widely known in aerial work platforms, and specifically, the moving means is provided as a quadrangular frame 100 equipped with rollers 100 so as be movable to a work position, and the work platform 20 is a so-called work space unit in which an operator is on board to perform high-space work, and has a space sufficient to load equipment for work, and the like as well as the operator, and has already commonly known components, such as a handrail for safety of the operator and an entrance, the detailed descriptions of which will be omitted.

Next, the lifting/lowering means 30 is a component foldably installed between the moving means 10 and the work platform 20 so as to lift/lower the work platform 20, wherein as illustrated in the drawing, unlike the prior art, a lifting/lowering means 30 in the present invention has a lift arm 340 whose both end portions and middle portions are pivotally connected to each other by a pivot pin 341 to form an ‘X’ shape in the form of a pantograph-type lift or scissor lift, wherein a plurality of the lift arms 340 form one set of a block-type lifting/lowering means 300, and the block-type lifting/lowering means 300 may be freely fastened or removed by an operator according to a working position, so that the block-type lifting means 300 may be detachable according to the height of the working position to be set and to an optimal height suitable for the working position and transported and moved, which is a technique of promoting convenience and simplicity of movement as illustrated in FIGS. 7 to 9.

Meanwhile, the number of the block-type lifting/lowering means 300 may be increased or decreased as desired by an operator, and a rough drawing thereof is illustrated in FIG. 1, and a drawing of an embodiment in which three block-type lifting/lowering means 300 are coupled and opened is illustrated in FIG. 2.

Hereinafter, the structure of the block-type lifting/lowering means 300 is as follows.

As illustrated in FIG. 3 and FIG. 4, the block-type lifting/lowering means 300 is composed of the fixing frame 310 provided vertically in a quadrangular shape, a long guide rail 320 provided at both opposite lower ends of the fixing frame 310, a sliding rod 330 to which one side of the lift arm 340 is coupled in a state in which the sliding rod 330 has a roller 331 provided at one end thereof so as to be slidable along the guide rail 320, and the lift arm 340 formed in an ‘X’ shape, which is the form of a pantograph-type lift or scissor lift, in a state in which the lift arm 340 has the pivot pin 341 provided in the center thereof so as to be foldable and expandable by the pivot pin 341.

The vertically-provided fixing frame 310 of the block-type lifting/lowering means 300 configured as described above is detachably fastened to each other with a coupling bracket 350.

That is, according to the fastening and releasing of the coupling bracket 350, an operator may fasten a desired number of block-type lifting/lowering means 300 between the work platform and the moving means 10.

Meanwhile, folding and opening of the lift arm 340 provided in the lifting/lowering means 300 are performed by any one fixing frame 310 among the vertically-provided fixing frames 310, which is provided with a DC actuator 360 to enable the lift arm 340 to be rotated by the pivot pin 341, thereby enabling the folding and opening.

For reference, the DC actuator 360 may be operated by a power means provided in a control box B provided on one side of the moving means 10 to be described below, or by a control unit C provided in the work platform 20, and in order to operate the DC actuator 360 as described above, an outlet (not shown in the drawing) capable of supplying power to the fixing frame 310 is provided.

However, although it is illustrated that a pantograph-type lift is applied to the aerial work platform according to an embodiment of the present invention, this does not limit the spirit of the present invention, and other types of lifts may also be used.

Next, as illustrated in FIG. 4 to FIG. 6, the moving means 10 has a structure of including

a fixing bar 110 having one side fixedly coupled to the pivot pin 341 provided in the center of the ‘X’-shaped lift arm 340 provided in the block-type lifting/lowering means 300 provided at the lowermost side, a lifting/lowering bar 120 having an elongated hole 121 formed therethrough and fixedly coupled to the other side of the fixing bar 110, a connecting bar 130 having a pin 131, which slides along the elongated hole 121, provided on one side, and having the other side fixedly coupled to a horizontal bar 140, a long horizontal bar 140 fixedly coupled at predetermined positions between opposite sides of the frame 100 and protruding outward from the opposite sides of the frame 100, thereby fixedly coupled to support bars 150, and the support bar 150 having one end fixedly coupled to the horizontal bar 140 and having the other end provided with a seating part 154 composed of a seating rod 153 having a pivot handle 151 penetratively coupled to an upper end thereof and having a contact plate 152 provided at a lower end thereof.

That is, the fixing bar 110 has one side fixedly coupled to the pivot pin 341, and the lifting/lowering bar 120 having an elongated hole 121 formed therethrough is fixedly coupled to the other side of the fixing bar 110.

Meanwhile, the connecting bar 130 having a pin 131, which slides along the elongated hole 121, provided on one side, and having the other side fixedly coupled to the horizontal bar 140 is formed, and the long horizontal bar 140 is fixedly coupled at predetermined positions between opposite sides of the frame 100, and protrudes outward from the opposite sides of the frame 100, thereby fixedly coupled to the support bars 150.

Meanwhile, the support bar 150 has one end fixedly coupled to the horizontal bar 140 and having the other end provided with the seating part 154 composed of the seating rod 153 having the pivot handle 151 penetratively coupled to an upper end thereof and having the contact plate 152 provided at a lower end thereof.

Hereinafter, the operation of the present invention will be described.

The core of the present invention is to detachably stack the block-type lifting/lowering means 300 such that the lifting/lowering means 30 may be adjusted according to a height desired by an operator so as to be suitable for a working portion, and

the block-type lifting/lowering means 300 and the moving means 10 are operated by power supply and operation of the control box B or the control unit C, and as illustrated in FIG. 4 and FIG. 9, first, the lift arm 340 is opened from a folded state by the operation of the DC actuator 360, and when the lift arm 340 is opened by the operation of the DC actuator 360, the sliding rod 330 is drawn to the center along the guide rail 320 provided in the fixing frame 310, and at the same time, as illustrated in FIG. 6, in a state in which the pin 131 of the connecting bar 130 is positioned at a front end of the elongated hole 121 provided in the lifting/lowering bar 120 as shown with dotted lines, the fixing bar 110 and the lifting/lowering bar 120 are lifted, which simultaneously allows the pin 131 to be located at a lower end of the elongated hole 121, so that the lift arm 340 is no longer lifted, and at this time, the support bar 150 fixedly coupled to the horizontal bar 140 by the simultaneous operation is fixedly coupled to the connecting bar 130 as illustrated in FIGS. 4 to 6 in a state perpendicular to the ground as illustrated in FIG. 3, and thus is rotated in a direction in contact with the ground, and in this rotated state, a fastener N is released as illustrated in FIG. 4 to withdraw the support bar 150 provided in a housing, and then the fastener N is fastened and fixed, and then the pivot handle 151 is rotated and released to allow the contact plate 152 provided at an end of the seating rod 153 to be brought into close contact with the ground, and then the pivot handle 151 is fastened and fixed.

That is, as described above, due to the opening of the support bar 150 of the moving means 10, the operation of opening the lift arm 340 while stably maintaining the same on the ground is simultaneously performed, and after work is completed, the entire operation is applied in the reverse order of the above order.

The present invention configured and operating as described above exhibits an effect of increasing work efficiency and economic feasibility by having a work platform provided with a detachable block-type lifting/lowering means in multiple stages to be able to remove or add a block-type lifting/lowering means without having to replace the same with a separate aerial or low-place work platform depending on a work position regardless of whether it is aerial work or low-place work, thereby improving convenience and speed of movement.

Although the present invention has been described above with reference to limited embodiments and drawings, the present invention is not limited to the above embodiments, and various modifications and variations may be made from the contents described above by those skilled in the art to which the present invention belongs.

Therefore, the technical idea of the present invention should be understood by the claims disclosed below, but it will be obvious that the equivalents or equivalent modifications thereof all belong to the scope of the technical idea of the present invention.

1. A block-type aerial work platform facilitating height adjustment comprising:
a moving means (10) provided as a quadrangular frame (100) equipped with rollers (101) so as to be movable to a work position;
a work platform (20) on which an operator boards to perform aerial work; and
a lifting/lowering means (30) foldably installed between the moving means (10) and the work platform (20) to lift/lower the work platform (20), wherein:
the lifting/lowering means (30) includes a plurality of detachably-stacked block-type lifting/lowering means (300), each having fixing frames (310) provided on both upper and lower sides, wherein between the fixing frames (310), a plurality of lift arms (340) are pivotally connected to each other at both end portions and middle portions thereof by pivot pins (341); and
the moving means (10) includes:
a fixing bar (110) having one side fixedly coupled to a pivot pin (341) provided in the center of the ‘X’-shaped lift arm (340) provided in the block-type lifting means (300) provided at the lowermost side;
a lifting/lowering bar (120) having an elongated hole (121) formed therethrough and fixedly coupled to the other side of the fixing bar (110);
a connecting bar (130) having a pin (131), which slides along the elongated hole (121), provided on one side, and having the other side fixedly coupled to a horizontal bar (140);
a long horizontal bar (140) fixedly coupled at predetermined positions between opposite sides of the frame (100) and protruding outward from the opposite sides of the frame (100), thereby fixedly coupled to support bars (150); and
the support bar (150) having one end fixedly coupled to the horizontal bar (140), and having the other end provided with a seating part (154) composed of a seating rod (153) having a pivot handle (151) penetratively coupled to an upper end thereof and having a contact plate (152) provided at a lower end thereof.

2. The block-type aerial work platform of claim 1, wherein the block-type lifting/lowering means (300) comprises:
the fixing frame (310) provided vertically in a quadrangular shape;
a long guide rail (320) provided at both opposite lower ends of the fixing frame (310);
a sliding rod (330) to which one side of the lift arm (340) is coupled in a state in which the sliding rod (330) has a roller 331 provided at one end thereof so as to be slidable along the guide rail (320); and
the lift arm (340) formed in an ‘X’ shape in a state in which the lift arm (340) has the pivot pin (341) provided in the center thereof so as to be foldable and expandable by the pivot pin (341).

3. The block-type aerial work platform of claim 1, wherein the vertically-stacked block-type lifting/lowering means (300) comprises the vertically-provided fixing frame (310) detachably fastened to each other with a coupling bracket (350).

4. The block-type aerial work platform of claim 1, wherein the fixing frame (310) provided on a lower side of the block-type lifting/lowering means (300) formed in multiple stages comprises a DC actuator (360) to enable the plurality of lift arms (340) to be rotatably lifted and lowered by the pivot pin (341).
